(19) United States
(12) Patent Application Publication
(10) Pub. No.: US 2007/0124379 A1
(43) Pub. Date: May 31, 2007

(54) Media-channel based interactive voice/video/data discussion-forums

(75) Inventors: Giorgio L. Coraluppi, Pittsburgh, PA (US); Gerard A. Pompa, Pittsburgh, PA (US); Jerome Schmitt, Pittsburgh, PA (US)

Correspondence Address: Ansel M. Schwartz;Attorney at Law, Suite 304, 201 N. Craig Street, Pittsburgh, PA, 15213, US

(73) Assignee: Chorus Call, Inc.

(21) Appl. No.: 11/599,757

(22) Filed: Nov. 15, 2006

Related U.S. Application Data
(60) Provisional application No. 60/739,565, filed on Nov. 23, 2005.

(51) Int. Cl. G06F 15/16

(52) U.S. Cl. 709/204

(57) ABSTRACT

A method for communicating includes the steps of presenting a topic on the media channel with a phone number or IP address to a real-time interactive forum regarding the topic. There is the step of calling the phone number or IP address by an individual. There is the step of entering the forum by the individual. There is the step of conversing with participants about the topic on the forum.

### FIELD OF THE INVENTION

The present invention is related to media-channel based interactive discussion-forums. More specifically, the present invention is related to media-channel based interactive discussion-forums that are formed from participants using a phone number or IP address presented with a topic of the media.

### BACKGROUND OF THE INVENTION

There is commonly a need or a desire for individuals to discuss issues of interest to them. These issues could involve current events, academic subjects, movie stars, religious subjects, or clothing styles to name but a few of an unlimited number of issues. Currently, there is no simple and easy way for individuals to discuss such issues over communication lines.

### SUMMARY OF THE INVENTION

The present invention pertains to a method for communicating. The method comprises the steps of presenting a topic on the media channel with a phone number or IP address to a real-time interactive forum regarding the topic. There is the step of calling the phone number or IP address by an individual. There is the step of entering the forum by the individual. There is the step of conversing with participants about the topic on the forum.

Provide a multipoint voice connection for a group of individuals to have a discussion about the specific subject matter associated with a Story within the Distributor media. The Distributor is potentially any media channel (i.e. newspaper, magazine, television, radio, internet search engines, web portals, web news agency, web-logs (blogs), etc.). The Story is any specific article, show or specific topic area established by the Distributor. The multipoint voice conversation will use a telephone or soft-phone and be connected using the PSTN network or Internet (VoIP).

### DETAILED DESCRIPTION

The present invention pertains to a method for communicating. The method comprises the steps of presenting a topic on the media channel with a phone number or IP address to a real-time interactive forum regarding the topic. There is the step of calling the phone number or IP address by an individual. There is the step of entering the forum by the individual. There is the step of conversing with participants about the topic on the forum.

Preferably, there is the step of using a multipoint collaboration equipment to establish and maintain the forum. The calling step preferably includes the step of using a telephone or soft phone for the individual to be connected using a PSTN network or Internet to enter the forum. Preferably, the multipoint equipment includes audio or video or data multipoint equipment or any combination thereof.

The conversing step preferably includes the step of talking with the participants, viewing data or seeing a video image, or any combination thereof. Preferably, the entering step includes the steps of greeting the individual with a message and guiding the individual to the forum. The entering step preferably includes the step of providing the individual with a URL or phone number. Preferably, there is the step of allowing a facilitator to mute or reject a participant from the forum. The method preferably includes the step of the facilitator moving from one form to another to assist in monitoring and facilitating many forums simultaneously.

Preferably, there are the steps of the facilitator creating sub forums, recording, playing pre-recorded information or calling out to a specialist/celebrity for addition to the forum. The method preferably includes the step of generating revenue from the forum through either ad based revenue, or participant direct payment or credit-card payment or account charge or network residual payment. Preferably, there is the step of charging the participants on a per party or per minute usage basis. The media channel is preferably either a newspaper, magazine, television show, radio show, Internet search engine, Web portal, Web news agency or Web-log.

The idea is to leverage audio/video/data multipoint collaboration technology to provide a new service targeted to any community or special interest group by using the vast array of media channels in the market today.

Media channels including print publications (magazines and newspapers) can offer to their subscribers the ability to collaborate with others in a real-time interactive forum regarding a specific topic of interest.

For example, when reading Newsweek magazine there may be article about some specific current event that includes at the conclusion of the article a phone number or IP address to call. The subscribers can then call and have a real-time, interactive discussion with a group of others interested in the same article. Based on the media channel preference the discussion can take place immediately or be scheduled for a specific time/date.

Another example is for a very specific technical journal to offer to their readers the ability to hold audio, video and data discussion forums concerning some new findings in a particular area of research. Again, this may be specifically associated with an article in the journal.

Other media channels such as television, radio programs, web-logs (blogs), web news portals, or other specific community portals may find it useful to associate a specific element (e.g. article, photo, entry) a way by which their audience could engage in an interactive voice discussion.

Internet search engines may offer a feature whereby once an end-user search on a specific topic a Category Relationship will be established and related voice discussion forums may be offered for the end-user to join either immediately or at some scheduled time in the future.

Multipoint communications technology which uses either PSTN phone numbers or a VoIP address to allow end-users to connect to a multipoint discussion group will be used to conference the voice/video/data end-users. The end-user can in real time interactively talk with others, view data and even see a video image. Voice messaging will greet the end user and guide them to the discussion forum. If there is multipoint data sharing also occurring then the end-user will be given a URL to connect. The voice/video/data discussion forum may be limited in number of participants or number of simultaneous forums. Operational features will allow a facilitator, who may or may not be involved, in the discussion forum to mute or eject any participant. Furthermore the facilitators will have the capability of moving from one discussion to another to assist in monitoring and facilitating many forums simultaneously. Other facilitator features may including creating sub forums, recording, playing pre recorded information, calling out to a specialist/celebrity for addition to the discussion forum.

The Service provider will need administration tools to allow them to quickly and easily create discussion forums since these may change daily or several times during the day to keep pace with changing news events or blog entries. The Summit and/or Orchestrator audio or video conferencing equipment sold by Compunetix, Inc. in Monroeville, Pa., could support the forums described herein.

Media Channels:

The distribution to the end-users can be via all forms of media, including television, radio, print media (periodicals, daily newspapers, etc.), as well as web-logs (blogs) or internet search engines or portal sites such as Google, MSN, Yahoo, etc. The intention of this new service is to provide the media-channel with a community building application which helps to retain and increase end-user subscribers.

Service Provider (Host):

The media channels will outsource the technology and operation of this new service to an outside service provider which takes the calls from the end-users and fulfills the audio, video and data collaboration requirements.

Branding:

The specific branding and actual features of this flexible service is driven by the media channel or any organization who is offering the service directly to the end-users.

Revenue Generation:

The media channel will decide on the revenue model for their specific offer:
1. Ad based revenue.
2. End-user direct payment, credit cards, paypal, etc.
3. Completely free service yielding other benefits to the MC including subscriber retention and subscriber growth.

The service provider may simply share in the revenue with the media channel who is offering the service to their subscribers. Or, the service provider may charge on a per party or per minute usage basis.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. A method for communicating comprising the steps of:
presenting a topic on the media channel with a phone number or IP address to a real-time interactive forum regarding the topic;
calling the phone number or IP address by an individual;
entering the forum by the individual; and
conversing with participants about the topic on the forum.

2. A method as described in claim 1 including the step of using a multipoint collaboration equipment to establish and maintain the forum.

3. A method as described in claim 2 wherein the calling step includes the step of using a telephone or soft phone for the individual to be connected using a PSTN network or Internet to enter the forum.

4. A method as described in claim 3 wherein the multipoint equipment includes audio or video or data multipoint equipment or any combination thereof.

5. A method as described in claim 4 wherein the conversing step includes the step of talking with the participants, viewing data or seeing a video image, or any combination thereof.

6. A method as described in claim 5 wherein the entering step includes the steps of greeting the individual with a message and guiding the individual to the forum.

7. A method as described in claim 6 wherein the entering step includes the step of providing the individual with a URL or phone number.

8. A method as described in claim 7 including the step of allowing a facilitator to mute or reject a participant from the forum.

9. A method as described in claim 8 including the step of the facilitator moving from one form to another to assist in monitoring and facilitating many forums simultaneously.

10. A method as described in claim 9 including the steps of the facilitator creating sub forums, recording, playing pre-recorded information or calling out to a specialist/celebrity for addition to the forum.

11. A method as described in claim 10 including the step of generating revenue from the forum through either ad based revenue, or participant direct payment or credit-card payment or account charge or network residual payment.

12. A method as described in claim 11 including the step of charging the participants on a per party or per minute usage basis.

13. A method as described in claim 12 wherein the media channel is either a newspaper, magazine, television show, radio show, Internet search engine, Web portal, Web news agency or Web-log.

14. A method of communicating comprising the steps of:
offering a phone number or IP address to an individual after an Internet search has been performed on a topic to a real-time interactive form regarding the topic;
calling the phone number or IP address by the individual;
entering the form by the individual; and
conversing with participants about the topic on the forum.

15. A method as described in claim 14 wherein the calling step includes the step of calling the phone number or IP address by the individual at a predetermined time.
